(19) United States
(12) Patent Application Publication
(10) Pub. No.: US 2016/0106087 A1
(43) Pub. Date: Apr. 21, 2016

(54) VERTICALLY COLLAPSIBLE OR HORIZONTALLY COLLAPSIBLE COCKROACH TRAP

(71) Applicant: BUG SCARE LIMITED, Kowloon (HK)

(72) Inventor: King Lun NG, Kowloon (HK)

(21) Appl. No.: 14/660,317

(22) Filed: Mar. 17, 2015

(30) Foreign Application Priority Data
Oct. 16, 2014 (CN) 201420600496.1

(51) Int. Cl. A01M 1/14; A01M 1/10; A01M 1/02

(52) U.S. Cl. CPC A01M 1/14; A01M 1/02; A01M 1/103

(57) ABSTRACT

This present invention relates to the technical field of a cockroach trap, and provides a vertically collapsible or horizontally collapsible cockroach trap, which includes an upper trap body and a lower trap body that are vertically extensible and retractable and interconnected to each other, where an inner cavity is formed between the upper trap body and the lower trap body, an adhesive sheet used to bond cockroaches, a cockroach attractant, and an anti-adhesion structure used to prevent bonding between the adhesive sheet and an inner wall of the inner cavity are disposed in the inner cavity, and an entrance available for cockroaches to enter the inner cavity is disposed on the upper trap body or the lower trap body. The anti-adhesion structure is applied to the vertically collapsible or horizontally collapsible cockroach trap, which avoids that the upper trap body and the lower trap body are hardly vertically extensible and retractable due to bonding of the adhesive sheet. During use, by vertically extending the upper trap body and the lower trap body, the inner cavity is expanded, and the entrance is opened, and cockroaches are tempted to enter the inner cavity and are then bonded by the adhesive sheet, which avoids a problem that a hand may touch the adhesive sheet and the cockroach attractant during use, which is very unsanitary, and avoids a problem that a cardboard needs to be folded manually into a cockroach trap, which is time-consuming and troublesome.

### TECHNICAL FIELD

This present invention relates to the technical field of a cockroach trap, and in particular, to a vertically collapsible or horizontally collapsible cockroach trap.

### BACKGROUND

Cockroaches are one of four major pests for the mankind. The cockroaches are the most harmful to the mankind, and have become a source of generation and dissemination of many diseases. Therefore, cockroach elimination is a primary task of many families.

Currently, a cockroach trap is widely applied to cockroach elimination in a home, and generally consists of a cut cardboard, an adhesive sheet, and a cockroach attractant. The cardboard is folded into a trap body, which is a trap body that covers the adhesive sheet and is used to catch cockroaches. To use the cockroach trap, the adhesive sheet is placed at the bottom of the trap body first, and then a piece of isolation paper for a purpose of isolation on the adhesive sheet is stripped off, and finally, a cockroach attractant is placed at the center of the adhesive sheet to entice cockroaches.

However, before the cockroach trap is put into use, the isolation paper needs to be torn off and the cockroach attractant with chemical constituents needs to be applied on the adhesive sheet. In this process, a hand may touch the adhesive sheet and the cockroach attractant, which is very unsanitary. In addition, the cardboard needs to be folded manually into a cockroach trap, which is time-consuming and troublesome.

### SUMMARY

The objective of this present invention is to provide a vertically collapsible or horizontally collapsible cockroach trap, and aims to solve a problem in an existing cockroach trap, namely, during use of the existing cockroach trap, a hand may touch an adhesive sheet and a cockroach attractant, which is very unsanitary, and a cardboard needs to be folded manually into the cockroach trap, which is time-consuming and troublesome.

To solve the foregoing technical problem, a technical solution to a vertically collapsible or horizontally collapsible cockroach trap provided in this present invention is as follows: The cockroach trap includes an upper trap body and a lower trap body that are vertically extensible and retractable and interconnected to each other, where an inner cavity is formed between the upper trap body and the lower trap body, an adhesive sheet used to bond cockroaches, a cockroach attractant, and an anti-adhesion structure used to prevent bonding between the adhesive sheet and an inner wall of the inner cavity are disposed in the inner cavity, and an entrance available for cockroaches to enter the inner cavity is disposed on the upper trap body or the lower trap body.

Further, the adhesive sheet is disposed on an inner side at the bottom of the lower trap body, and the anti-adhesion structure is disposed on an inner side at the top of the upper trap body.

Further, the adhesive sheet is supported between an upper inner side and a lower inner side of the inner cavity, and the anti-adhesion structure is disposed on both the upper trap body and the lower trap body.

Further, two lateral ends of the upper trap body and the lower trap body are interconnected to form flat structures available for a user to tear off, and a reinforced structure used to reinforce strength of a sidewall is disposed on both the upper trap body and the lower trap body.

Further, the adhesive sheet is rotationally connected onto a sidewall of the inner cavity.

Further, the upper trap body is integrally connected to the lower trap body to form a rectangular block whose upper surface and lower surface are collapsible, and openings are made at two lateral ends of the rectangular block to form the entrances.

Further, a left side and a right side of the upper trap body are interconnected to those of the lower trap body, openings are formed on a front side and a rear side, semi-hollowed-out creases are disposed on a side edge of the left side and a side edge of the right side correspondingly, and two ends of the creases extend to the openings at the front side and the rear side separately.

Further, the anti-adhesion structure is isolation paper, an anti-adhesion agent, silicone oil or a bulge that is disposed on the inner side of the upper trap body or disposed on the inner side of the lower trap body.

Further, the entrance is an air hole used to connect the inner cavity to the outside.

Further, a handle that is conveniently available for a user to vertically extend and retract the upper trap body and the lower trap body is disposed on the upper trap body and the lower trap body separately.

Compared with the prior art, this present invention brings the following beneficial effects:

Because an anti-adhesion structure is applied to the vertically collapsible or horizontally collapsible cockroach trap, it is avoided that an upper trap body and a lower trap body are hardly vertically extensible and retractable due to bonding of an adhesive sheet. Therefore, during use, by vertically extending the upper trap body and the lower trap body, an inner cavity is expanded, a volume enlarges, and an entrance is opened. In this case, a cockroach attractant emits an attractant odor, which is dispersed from the entrance into air outside the inner cavity and tempts cockroaches to enter the inner cavity from the entrance, so that the cockroaches can be bonded by the adhesive sheet. In this way, by vertically extending the upper trap body and the lower trap body of the collapsible cockroach trap, the cockroaches can be caught. Compared with the cockroach trap in the prior art, the cockroach trap in this present invention avoids a problem that a hand may touch the adhesive sheet and the cockroach attractant during use, which is very unsanitary, and avoids a problem that a cardboard needs to be folded manually into a cockroach trap, which is time-consuming and troublesome.

### BRIEF DESCRIPTION OF DRAWINGS

FIG. 1 is a three-dimensional schematic structural diagram of a vertically collapsible or horizontally collapsible cockroach trap according to this present invention;

FIG. 2 is a sectional view when an anti-adhesion structure of a vertically collapsible or horizontally collapsible cockroach trap is isolation paper according to Embodiment 1 of this present invention;

FIG. 3 is a sectional view when an anti-adhesion structure of a vertically collapsible or horizontally collapsible cockroach trap is silicone oil according to Embodiment 1 of this present invention;

FIG. 4 is a sectional view when an anti-adhesion structure of a vertically collapsible or horizontally collapsible cockroach trap is a bulge according to Embodiment 1 of this present invention;

FIG. 5 is a sectional view of a vertically collapsible or horizontally collapsible cockroach trap according to Embodiment 2 of this present invention;

FIG. 6 is another sectional view of a vertically collapsible or horizontally collapsible cockroach trap according to Embodiment 2 of this present invention;

FIG. 7 is a three-dimensional schematic structural diagram of a vertically collapsible or horizontally collapsible cockroach trap before being put into use according to Embodiment 3 of this present invention;

FIG. 8 is a three-dimensional schematic structural diagram of a vertically collapsible or horizontally collapsible cockroach trap during use according to Embodiment 3 of this present invention;

FIG. 9 is a three-dimensional schematic structural diagram of a vertically collapsible or horizontally collapsible cockroach trap during use according to Embodiment 4 of this present invention;

FIG. 10 is a three-dimensional schematic structural diagram of a vertically collapsible or horizontally collapsible cockroach trap with a handle according to this present invention;

FIG. 11 is a three-dimensional schematic structural diagram of the vertically collapsible or horizontally collapsible cockroach trap during use, which is provided in FIG. 10;

FIG. 12 is a top view of a vertically collapsible or horizontally collapsible cockroach trap when a crease is an arc according to Embodiment 5 of this present invention;

FIG. 13 is a three-dimensional schematic structural diagram of a vertically collapsible or horizontally collapsible cockroach trap before being put into use according to Embodiment 5 of this present invention;

FIG. 14 is a three-dimensional schematic structural diagram of a vertically collapsible or horizontally collapsible cockroach trap during use according to Embodiment 5 of this present invention;

FIG. 15 is a top view of a vertically collapsible or horizontally collapsible cockroach trap when a crease is a straight line according to Embodiment 5 of this present invention; and

FIG. 16 is another top view of a vertically collapsible or horizontally collapsible cockroach trap when a crease is an arc according to Embodiment 5 of this present invention.

### DESCRIPTION OF EMBODIMENTS

To make the objectives, technical solutions, and advantages of this present invention clearer and more comprehensible, the following further describes this present invention in more detail with reference to the accompanying drawings and embodiments. It should be understood that the specific embodiments described herein are merely used to explain this present invention but are not intended to limit this present invention.

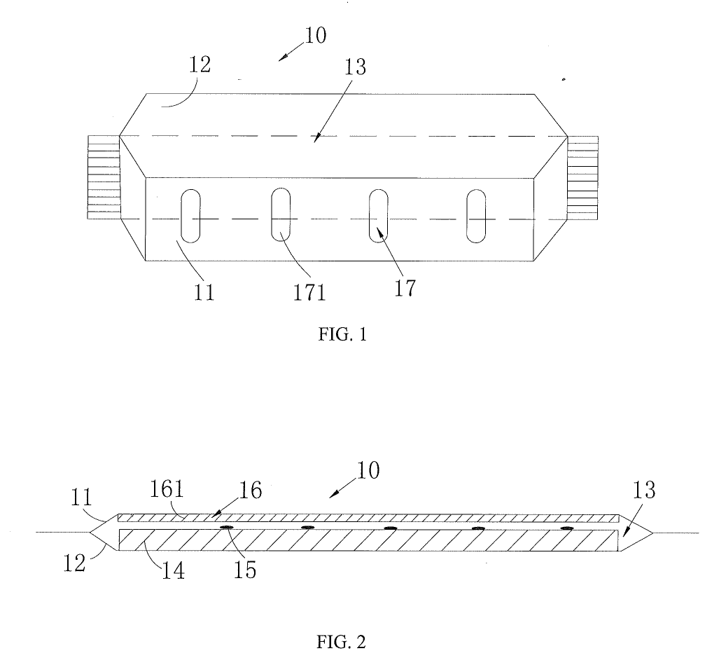

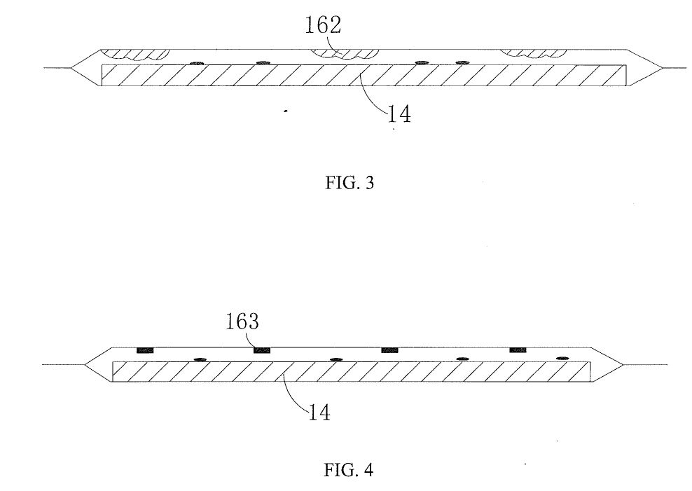

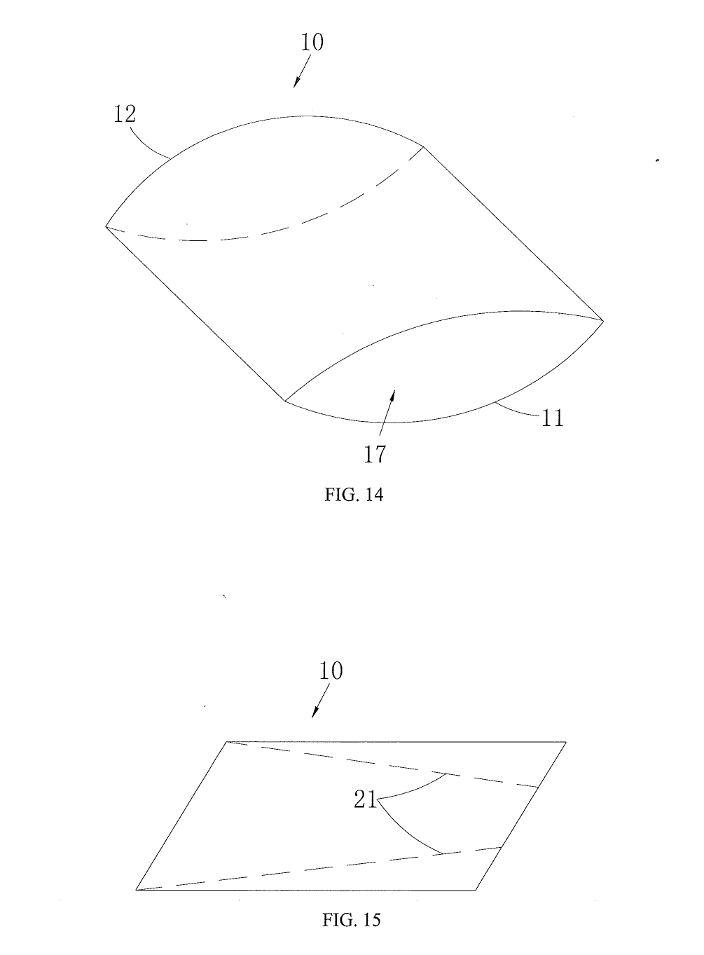

FIG. 1 to FIG. 16 show preferred embodiments of this present invention.

It should be noted that when a component is “fixed” or “disposed” on another component, the component may be placed on the another component directly or an intermediate component may exist. When a component, is “connected” to another component, the component may be connected to the another component directly or an intermediate component may exist.

It should further be noted that orientation terms such as left, right, upper, and lower in the embodiments are merely relative concepts, or a normal use state of a product is used as a reference, but the terms should not be regarded as restrictive.

A vertically collapsible or horizontally collapsible cockroach trap 10 provided in an embodiment is widely applicable to cockroach elimination in homes and also applicable to catching of geckos and pests such as mice.

As shown in FIG. 1 and FIG. 2, the cockroach trap includes an upper trap body 11 and a lower trap body 12 that are vertically extensible and retractable and interconnected to each other, where an inner cavity 13 is formed between the upper trap body 11 and the lower trap body 12, an adhesive sheet 14 used to bond cockroaches, a cockroach attractant 15, and an anti-adhesion structure 16 used to prevent bonding between the adhesive sheet 14 and an inner wall of the inner cavity 13 are disposed in the inner cavity 13, and an entrance 17 available for cockroaches to enter the inner cavity 13 is disposed on the upper trap body 11 or the lower trap body 12.

It should be noted that as shown in FIG. 1 and FIG. 2, before the vertically collapsible or horizontally collapsible cockroach trap 10 is put into use, the upper trap body 11 and the lower trap body 12 are collapsed and fitted into a flat shape to save storage space and facilitate packaging and storage. The entrance 17 is sealed due to fitting of the upper trap body 11 and the lower trap body 12. Alternatively, a sealing structure is used to seal the entrance 17. The sealed entrance 17 can prevent volatilization of the cockroach attractant 15, and prevent attractant odor from being dispersed from the entrance 17 into air outside the inner cavity 13 before the vertically collapsible or horizontally collapsible cockroach 10 is put into use, which will lose attractant effects of the cockroach attractant 15.

Compared with the prior art, the vertically collapsible or horizontally collapsible cockroach trap 10 according to this embodiment brings the following beneficial effects:

As shown in FIG. 1 and FIG. 2, because an anti-adhesion structure 16 is applied to the vertically collapsible or horizontally collapsible cockroach trap 10, it is avoided that an upper trap body 11 and a lower trap body 12 are hardly vertically extensible and retractable due to bonding of an adhesive sheet 14. Therefore, during use, by vertically extending the upper trap body 11 and the lower trap body 12, an inner cavity 13 is expanded, a volume enlarges, and an entrance 17 is opened. In this case, a cockroach attractant 15 emits an attractant odor, which is dispersed from the entrance 17 into air outside the inner cavity 13 and tempts cockroaches to enter the inner cavity 13 from the entrance 17, so that the cockroaches can be bonded by the adhesive sheet 14. In this way, by vertically extending the upper trap body 11 and the lower trap body 12 of the collapsible cockroach trap, the cockroaches can be caught. Compared with the cockroach trap in the prior art, the cockroach trap in this present invention avoids a problem that a hand may touch the adhesive sheet and the cockroach attractant 15 during use, which is very unsanitary, and avoids a problem that a cardboard needs to be folded manually into a cockroach trap, which is time-consuming and troublesome.

It should be noted that as shown in FIG. 1, a material of the upper trap body 11 and the lower trap body 12 may be paper, plastic, or two-layer paper made of aluminum and paper, or the like. Preferably, in this embodiment, the material of the upper trap body 11 and the lower trap body 12 is paper. In other embodiments, the material of the upper trap body 11 and the lower trap body 12 may be other materials so long as a use condition is satisfied, where the use condition is that the upper trap body 11 and the lower trap body 12 are vertically extensible.

The following is Embodiment 1 of the vertically collapsible or horizontally collapsible cockroach trap 10 provided by this present invention:

As shown in FIG. 1 to FIG. 4, the adhesive sheet 14 is disposed on an inner side at the bottom of the lower trap body 12, the anti-adhesion structure 16 is disposed on an inner side at the top of the upper trap body 11, and the anti-adhesion structure 16 may be isolation paper 161, an anti-adhesion agent (not shown in the figure), silicone oil 162, or a bulge 163. The entrance 17 is an air hole 171 used to connect the inner cavity 13 to the outside, and the air hole 171 is disposed on the upper trap body 11 or the lower trap body 12. Preferably, the air hole 171 runs through an upper surface of the upper trap body 11. The sealing structure of the air hole 171 may be a sticker or a semi-pierced material. The cockroach attractant 15 may be disposed on the adhesive sheet 14 or the inner wall of the inner cavity 13 so long as a use condition is satisfied, where the use condition is that the cockroach attractant 15 is disposed in the inner cavity 13.

An operation process is as follows: As shown in FIG. 1 to FIG. 4, because the anti-adhesion structure 16 such as isolation paper 161, an anti-adhesion agent, silicone oil 162, or a bulge 163 is applied, the inner side at the top of the upper trap body 11 is not easily bondable to the adhesive sheet 14 and is smoothly extensible and retractable up and down. Therefore, when the vertically collapsible or horizontally collapsible cockroach trap 10 is put into use, first the sealing structure of the air hole 171 is torn off, for example, the sticker is torn off, so that the entrance 17 is opened, and then the upper trap body 11 is extended upward. With the upper trap body 11 being gradually far away from the adhesive sheet 14, external air flows from the air hole 171 into the inner cavity 13 gradually, and the volume of the inner cavity 13 becomes larger. When the upper trap body 11 is extended to the utmost, the volume of the inner cavity 13 is the largest. In this case, the cockroach attractant 15 emits an attractant odor, which tempts the cockroaches to enter the inner cavity 13 from the air hole 171.

The following is Embodiment 2 of the vertically collapsible or horizontally collapsible cockroach trap 10 provided by this present invention:

Embodiment 2 is roughly the same as Embodiment 1 in structure, but differs in that:

As shown in FIG. 1 to FIG. 6, the adhesive sheet 14 is supported between an upper inner side and a lower inner side of the inner cavity 13, and the anti-adhesion structure 16 is disposed on both the upper trap body 11 and the lower trap body 12. An adhesive is disposed on an upper surface and a lower surface of the adhesive sheet 14, and the anti-adhesion structure 16 may be isolation paper 161, an anti-adhesion agent, silicone oil 162, or a bulge 163. The same anti-adhesion structure 16 such as isolation paper 161, an anti-adhesion agent, silicone oil 162, or a bulge 163 may be disposed on both the upper trap body 11 and the lower trap body 12, or different anti-adhesion structures 16 may be disposed separately, that is, any two of the foregoing anti-adhesion structures 16 may be disposed. For example, isolation paper 161 is disposed on the upper trap body 11, and a bulge 163 is disposed on the lower trap body 12, or the like.

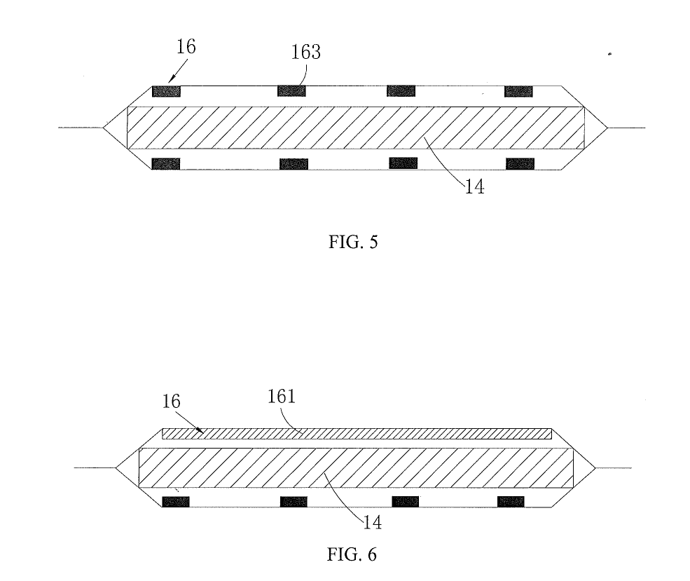

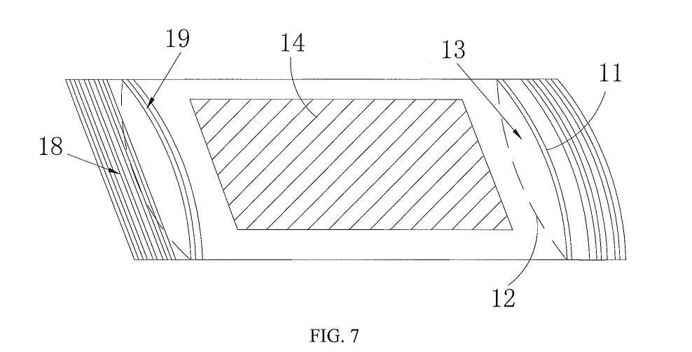

An operation process is as follows: As shown in FIG. 1, FIG. 5, and FIG. 6, when the vertically collapsible or horizontally collapsible cockroach trap 10 is put into use, first the sticker on the air hole 171 is torn off so that the entrance 17 is opened, and then the upper trap body 11 is extended upward and the lower trap body 12 is extended downward at the same time. With the upper trap body 11 and the lower trap body 12 being gradually far away from the adhesive sheet 14, external air fills the inner cavity 13 gradually until the volume of the inner cavity 13 becomes the largest. Finally, under the attractant effect of the cockroach attractant, cockroaches enter the inner cavity 13 from the air hole 171 and are bonded by the adhesive on the adhesive sheet 14.

As shown in FIG. 2, FIG. 5 and FIG. 6, compared with Embodiment 1, Embodiment 2 makes better use of the space on the adhesive sheet 14 to dispose the adhesive. Therefore, the vertically collapsible or horizontally collapsible cockroach trap 10 according to Embodiment 2 has a wider adhesion area for catching cockroaches, which enhances effects of catching cockroaches.

The following is Embodiment 3 of the vertically collapsible or horizontally collapsible cockroach trap 10 provided by this present invention:

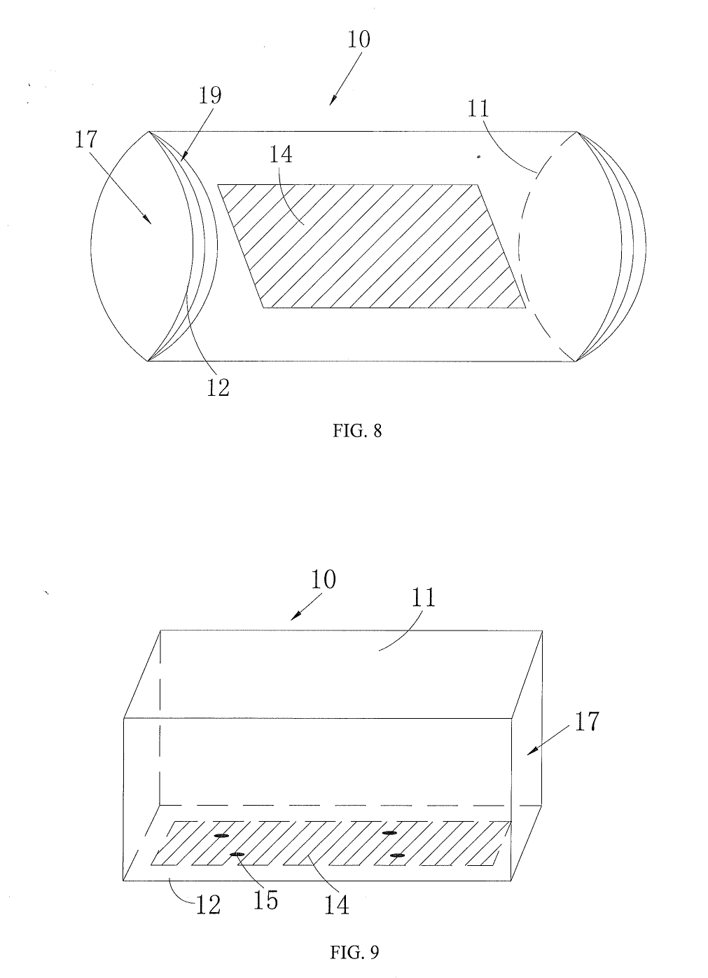

As shown in FIG. 7 and FIG. 8, two lateral ends of the upper trap body 11 and the lower trap body 12 are interconnected to form flat structures 18 available for a user to tear off, and a reinforced structure 19 used to reinforce strength of a sidewall is disposed on both the upper trap body 11 and the lower trap body 12.

Refer to FIG. 2 to FIG. 4, and FIG. 7 and FIG. 8. The adhesive sheet 14 in this embodiment may be disposed on the inner side at the bottom of the lower trap body 12, or supported between the upper inner side and the lower inner side of the inner cavity 13. The anti-adhesion structure 16 may be disposed on the inner side at the top of the upper trap body 11, or disposed on the inner side at the bottom of the lower trap body 12. The anti-adhesion structure 16 may be isolation paper 161, an anti-adhesion agent, silicone oil 162, or a bulge 163. The cockroach attractant 15 only needs to satisfy the use condition that it is disposed in the inner cavity 13.

An operation process is as follows: As shown in FIG. 7 and FIG. 8, during use, the flat structures 18 at both ends are torn off first. Two notches exist on the two ends after the flat structures 18 are torn off. The two notches become entrances 17 for cockroaches to enter the inner cavity 13. The flat notches at the two ends are squeezed at the same time to swell the notches. Because a reinforced structure 19 is disposed on the sidewalls of the upper trap body 11 and the lower trap body 12, the strength of the sidewalls is reinforced. Therefore, the swollen notches can keep the yawning state better. In this way, it is easier for the cockroach attractant 15 to emit an attractant odor and tempt more cockroaches to enter the inner cavity 13.

It should be pointed out that as shown in FIG. 7, the reinforced structure 19 is a flexible iron wire or a cardboard, or the strength of the sidewall is reinforced by increasing the thickness of the sidewall. Preferably, the reinforced structure 19 should further be disposed on the sidewall adjacent to the flat structure 18, namely, at the notch.

In addition, as shown in FIG. 7, the adhesive sheet 14 is rotationally connected onto the sidewall of the inner cavity 13. After the flat structures 18 at both ends are torn off, the adhesive sheet 14 may be rotated so that the adhesive sheet 14 is vertical to a flat plane of the flat structure 18. In this way, the notches will swell under a flaring effect of the adhesive sheet 14. The adhesive sheet 14 is stably supported under a rebound force effect of the sidewall of the inner cavity 13; or, after the adhesive sheet 14 is rotated, a fixing structure is disposed to fix the adhesive sheet 14, which also lets the adhesive sheet 14 be supported on the sidewall of the inner cavity 13 stably.

It should be noted that as shown in FIG. 7 and FIG. 8, the flared notch is an oval shape. That is, the entirety formed by the upper trap body 11 and the lower trap body 12 is an oval shape. During use, the vertically collapsible or horizontally collapsible cockroach trap 10 may be disposed on the ground, and the adhesive sheet 14 in the oval inner cavity 13 is somewhat above the ground. In this way, the adhesive on the adhesive sheet 14 is invulnerable to moisture, the bonding force lasts longer, and the cockroach attractant is more endurable.

The following is Embodiment 4 of the vertically collapsible or horizontally collapsible cockroach trap 10 provided by this present invention:

As shown in FIG. 9, the upper trap body 11 is integrally connected to the lower trap body 12 to form a rectangular block whose upper surface and lower surface are collapsible, and openings are made at two lateral ends of the rectangular block to form the entrances 17.

Before being put into use, the upper trap body 11 and the lower trap body 12 are collapsed into a flat shape, so that the entrances 17 at the two lateral ends of the rectangular block are flattened and closed. During use, the upper trap body 11 and the lower trap body 12 are extended upward and downward, so that the rectangular block is extended to form a cube. In this case, the entrances 17 at the two lateral ends of the rectangular block are opened, and cockroaches are tempted to enter the inner cavity of the rectangular block from the entrances 17.

The following is Embodiment 5 of the vertically collapsible or horizontally collapsible cockroach trap 10 provided by this present invention:

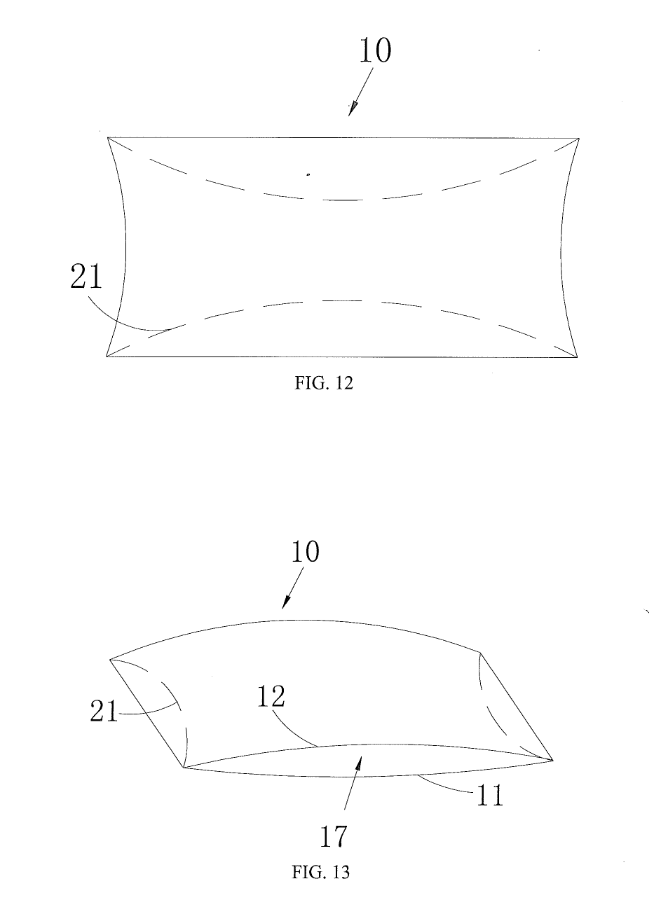

Refer to FIG. 1 to FIG. 6, and FIG. 12 to FIG. 16 for the following description.

As shown in FIG. 12 and FIG. 13, a left side and a right side of the upper trap body 11 are interconnected to those of the lower trap body 12, the entrances 17 are formed on a front side and a rear side, semi-hollowed-out creases 21 are disposed on a side edge of the left side and a side edge of the right side correspondingly, and two ends of the creases 21 extend to the entrances 17 at the front side and the rear side separately.

As shown in FIG. 2, FIG. 12, and FIG. 13, the upper trap body 11 and the lower trap body 12 are collapsed into a flat shape. During use, the side edges on the left side and the right side of the upper trap body 11 and the lower trap body 12 are pushed and squeezed so that they are retracted toward the inner cavity 13. The side edges on the left side and the right side flare out the upper trap body 11 and the lower trap body 12 along the route of the creases 21, and the upper trap body 11 and the lower trap body 12 are separated smoothly under an effect of the anti-adhesion structure 16, and swell outward gradually. In this case, the inner cavity 13 expands gradually, and the entrances 17 located on the front side and the rear side are opened gradually.

Preferably, as shown in FIG. 2, FIG. 12, and FIG. 13, the entrances 17 enclosed by the upper trap body 11 and the lower trap body 12 whose cross sections are arcs. Therefore, while the entrances 17 on two sides are opened gradually, the arc tops and bottoms of the upper trap body 11 and the lower trap body 12 are pulled open first, and are pulled open to the greatest extent and the longest distance. Interconnection joints on two sides at the top and the bottom of the arcs will be separated last. Correspondingly, the anti-adhesion structure 16 is separated from the adhesive sheet 14 gradually, where the separation begins at the joint at the top and the bottom and extends toward two sides.

It should be noted that as shown in FIG. 2 to FIG. 4, the anti-adhesion structure 16 may be isolation paper 161, an anti-adhesion agent, silicone oil 162, a bulge 163, or the like.

As shown in FIG. 12, FIG. 13, and FIG. 15, in this embodiment, the shape of the creases 21 is a straight line shape or an arc shape. In other embodiments, the shape of the creases 21 may be other shapes so long as a use condition is satisfied, where the use condition is that the upper trap body 11 and the lower trap body 12 are flared out along the route of the creases 21.

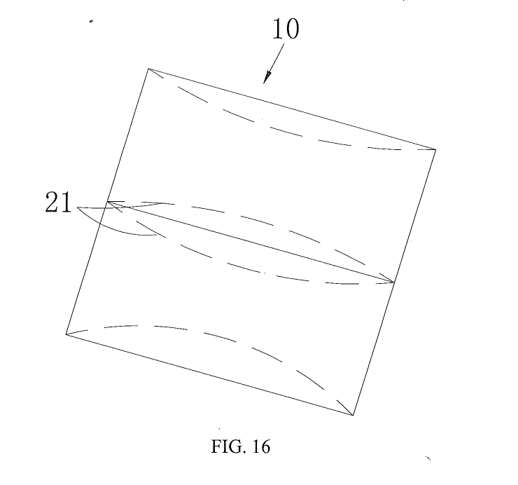

As shown in FIG. 13 and FIG. 16, certainly, the creases 21 on the upper trap body 11 and the lower trap body 12 may be specifically located at the side edge along which the left side and the right side of the upper trap body 11 are interconnected to those of the lower trap body 12, and may extend toward the center. Specifically, the creases may be disposed according to actual conditions so long as the use condition is satisfied, where the use condition is that the upper trap body 11 and the lower trap body 12 are flared out along the route of the creases 21.

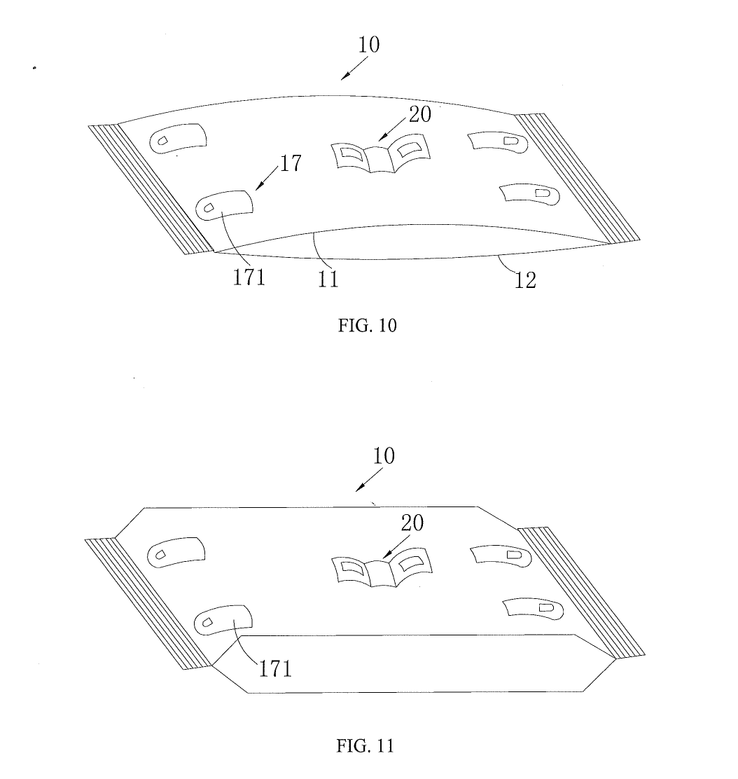

As shown in FIG. 10 and FIG. 11, to make it convenient for a user to vertically collapse the upper trap body 11 and the lower trap body 12, a handle 20 is disposed on the upper trap body 11 and the lower trap body 12 separately.

The foregoing descriptions are merely preferred embodiments of this present invention, but are not intended to limit this present invention. Any modification, equivalent replacement, and improvement made without departing from the spirit and principle of this present invention shall fall within the protection scope of this present invention.

What is claimed is:

1. A vertically collapsible or horizontally collapsible cockroach trap, comprising an upper trap body and a lower trap body that are vertically extensible and retractable and interconnected to each other, wherein an inner cavity is formed between the upper trap body and the lower trap body, an adhesive sheet used to bond cockroaches, a cockroach attractant, and an anti-adhesion structure used to prevent bonding between the adhesive sheet and an inner wall of the inner cavity are disposed in the inner cavity, and an entrance available for cockroaches to enter the inner cavity is disposed on the upper trap body or the lower trap body.

2. The vertically collapsible or horizontally collapsible cockroach trap according to claim 1, wherein the adhesive sheet is disposed on an inner side at the bottom of the lower trap body, and the anti-adhesion structure is disposed on an inner side at the top of the upper trap body.

3. The vertically collapsible or horizontally collapsible cockroach trap according to claim 1, wherein the adhesive sheet is supported between an upper inner side and a lower inner side of the inner cavity, and the anti-adhesion structure is disposed on both the upper trap body and the lower trap body.

4. The vertically collapsible or horizontally collapsible cockroach trap according to claim 1, wherein two lateral ends of the upper trap body and the lower trap body are interconnected to form flat structures available for a user to tear off, and a reinforced structure used to reinforce strength of a sidewall is disposed on both the upper trap body and the lower trap body.

5. The vertically collapsible or horizontally collapsible cockroach trap according to claim 4, wherein the adhesive sheet is rotationally connected onto a sidewall of the inner cavity.

6. The vertically collapsible or horizontally collapsible cockroach trap according to claim 1, wherein the upper trap body is integrally connected to the lower trap body to form a rectangular block whose upper surface and lower surface are collapsible, and openings are made at two lateral ends of the rectangular block to form the entrances.

7. The vertically collapsible or horizontally collapsible cockroach trap according to claim 1, wherein a left side and a right side of the upper trap body are interconnected to those of the lower trap body, openings are formed on a front side and a rear side, semi-hollowed-out creases are disposed on a side edge of the left side and a side edge of the right side correspondingly, and two ends of the creases extend to the openings at the front side and the rear side separately.

8. The vertically collapsible or horizontally collapsible cockroach trap according to claim 1, wherein the anti-adhesion structure is isolation paper, an anti-adhesion agent, silicone oil or a bulge that is disposed on the inner side of the upper trap body or disposed on the inner side of the lower trap body.

9. The vertically collapsible or horizontally collapsible cockroach trap according to claim 1, wherein the entrance is an air hole used to connect the inner cavity to the outside.

10. The vertically collapsible or horizontally collapsible cockroach trap according to claim 1, wherein a handle that is conveniently available for a user to vertically extend and retract the upper trap body and the lower trap body is disposed on the upper trap body and the lower trap body separately.
